(19) United States
(12) Patent Application Publication
(10) Pub. No.: US 2009/0258204 A1
(43) Pub. Date: Oct. 15, 2009

(54) SUBSTRATES COATED WITH OLEFIN POLYMERS FOR ELECTROPHOTOGRAPHIC PRINTING METHOD

(75) Inventors: Hildegard Stein, Mannheim (DE); Roland Ettl, Ketsch (DE); Thomas Pfeiffer, Böhl-Iggelheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/301,618

(22) PCT Filed: May 16, 2007
(86) PCT No.: PCT/EP07/54732

§ 371 Date: Nov. 20, 2008

(30) Foreign Application Priority Data
May 24, 2006 (EP) 06114480.4

(51) Int. Cl. B32B 27/10; B05D 5/00; G03G 15/00

(52) U.S. Cl. 428/211.1; 427/261; 427/256; 427/288; 428/195.1; 399/38

(57) ABSTRACT

A process for printing on substrates, wherein the substrates are pretreated with a composition which comprises a polymer obtainable by free radical polymerization of ethylenically unsaturated compounds (monomers) (referred to below as polymer for short), and at least 40% by weight of the monomers are olefins.

The invention relates to a process for printing on substrates, wherein the substrates are pretreated with a composition which comprises a polymer obtainable by free radical polymerization of ethylenically unsaturated compounds (monomers) (referred to below as polymer for short), and at least 40% by weight of the monomers are olefins.

An essential feature of electrophotographic printing processes is that electrostatically charged dye systems, so-called toners, are used and an electrostatic charge image which can be developed in various ways is produced.

In the electrophotographic printing processes, two physically different toner systems are used: dry toners (i.e. toners which are present in solid form at room temperature and become liquid only under the action of heat at relatively high temperatures of about 130° C.) and liquid toners (toners which have a very low melting point).

Electrostatic printing processes using a liquid toner are also referred to as LEP (liquid electrostatic printing) or indigo printing processes.

Owing to the low melting point and low fixing temperature of the toner on the paper (in general from 40 to 100° C.), the toner adhesion to paper in the LEP process is frequently insufficient.

WO 96/06384 describes the improvement of the adhesion of the liquid toner on paper substrates by treatment of the surface with substances which carry a basic functionality, exclusively and preferably polyethylenimines (PEI), ethoxylated PEI, epichlorohydrins-polyethylenimines and polyamides being mentioned. A decisive disadvantage of this method of treatment, however, is the loss of whiteness and the yellowing of the paper on prolonged storage.

U.S. Pat. No. 5,281,507 describes the use of (partly) fluorinated hydrocarbons or surfactants on a substrate surface for improving the printed image and the toner adhesion.

In EP-A 0 879 917, mixtures of salts (e.g. aluminate salts or salts of a weak acid and a strong base) are used in order to impart to the paper surface an alkaline pH which in turn results in improved printability by means of liquid toner.

WO 2004/092483 describes the surface treatment of paper with a combination of starch, an acrylic acid polymer and a further organic compound, e.g. a polyglyceryl ester. The use of the polyglyceryl ester is regarded as essential for achieving good toner fixing.

WO 2005/033155 describes ethylene copolymers containing amino groups. A surface treatment of paper is not mentioned.

It was an object of the present invention to improve the electrostatic printing processes, in particular the LEP process. It was also the object to provide suitable substrates for such printing processes. By measures which are as simple as possible, it was intended in particular to permit as good fixing as possible of the liquid toner on different paper grades.

Accordingly, the process defined above was found.

An essential feature of the invention is that the substrates are pretreated with a composition which comprises a polymer obtainable by free radical polymerization of ethylenically unsaturated compounds (monomers) (referred to below as polymer for short), and at least 40% by weight of the monomers are olefins.

Composition

Regarding the Polymer

The polymer comprises at least 40% by weight, preferably at least 60% by weight and particularly preferably at least 80% by weight of olefins. The olefins are in particular ethylene, propylene or isobutylene or mixtures thereof. Ethylene is preferred. The polymer may be a homopolymer of the above monomers, in particular polyethylene.

The polymer may comprise further monomers in addition to the olefins.

The polymer preferably comprises monomers having primary, secondary, tertiary or quaternary amino groups in addition to the olefins. Amino groups having tertiary or quaternary amino groups are preferred. The latter are cationic groups, and the associated anion is, for example, the anion of hydrogen acids, such as the chloride anion or sulfate anion.

Quaternary amino groups obtainable by polymer-analogous reaction of a primary or secondary amino group with an alkylating agent R—X, where R is selected from benzyl and C1-C10-alkyl and X is selected from halogen and R—SO4, are particularly preferred.

The polymer is preferably composed of
(a) from 50 to 99% by weight, in particular from 45 to 90% by weight, of olefins, preferably ethylene,
(b) from 1 to 50% by weight, in particular from 5.5 to 45% by weight, of at least one monomer having a primary, secondary, tertiary or quaternary amino group and
(c) from 0 to 30% by weight, in particular from 0 to 20% by weight, of a further monomer.

Data in % by weight are based in each case on polymer.

The polymer preferably has a weight average molecular weight M_{w} in the range of from 1000 to 500 000, in particular from 1000 to 200 000, particularly preferably from 1000 to 100 000, particularly preferably from 1000 to 60 000, g/mol and, in a particular embodiment, from 2000 to 50 000 g/mol.

The polymer is preferably present as an aqueous dispersion or solution.

Suitable monomers (b) are those having any desired amino groups. The amino group may also be part of a heterocyclic ring, for example N-vinylimidazole.

(b) is preferably formally a comonomer which has at least one alkylated or cycloalkylated amino group which in each case is linked via a spacer to a polymerizable group.

The alkylated or cycloalkylated amino group of comonomer (b) may be mono- or polyalkylated or mono- or polycycloalkylated. If it is desired to incorporate a plurality of comonomers (b) in the form of polymerized units the various comonomers (b) may have identical or different spacers or may have identical or different polymerizable groups or may carry identical or different alkyl groups or cycloalkyl groups on the amino group or groups. It is also conceivable within the scope of the present invention for at least one comonomer (b) to have two or more alkylated or cycloalkylated amino groups which in each case are linked via a spacer to a polymerizable group.

In a preferred embodiment, at least one comonomer (b) corresponds to the general formula I

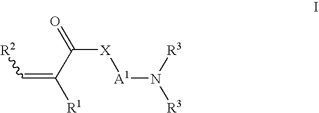

in which the variables are defined as follows:

R¹ and R² are identical or different;

R² is selected from hydrogen and

straight-chain and branched C₁-C₁₀-alkyl, such as, for example, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; particularly preferably C₁-C₄-alkyl, such as methyl, ethyl, n-propyl, isopropyl, n-butyl, isobutyl, sec-butyl and tert-butyl, in particular methyl;

R² is selected from straight-chain and branched C₁-C₁₀-alkyl, such as, for example, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; particularly preferably C₁-C₄-alkyl, such as methyl, ethyl, n-propyl, isopropyl, n-butyl, isobutyl, sec-butyl and tert-butyl, in particular methyl;

and very particularly preferably hydrogen.

R³ are different or preferably identical and are selected from hydrogen and branched and preferably straight-chain C₁-C₁₀-alkyl, for example methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; preferably methyl, ethyl, n-propyl, n-butyl, n-pentyl, isopentyl, n-hexyl, n-heptyl, n-octyl, n-nonyl, n-decyl; particularly preferably C₁-C₄-alkyl, such as methyl, ethyl, n-propyl, isopropyl, n-butyl, isobutyl, sec-butyl and tert-butyl, very particularly preferably methyl;

C₃-C₁₂-cycloalkyl, such as, for example, cyclopropyl, cyclobutyl, cyclopentyl, cyclohexyl, cycloheptyl, cyclooctyl, cyclononyl, cyclodecyl, cycloundecyl and cyclododecyl; cyclopentyl, cyclohexyl and cycloheptyl are preferred, it being possible for two radicals R³ to be linked to one another with formation of a 3- to 10-membered, preferably 5- to 7-membered ring which is optionally substituted by C₁-C₄-alkyl radicals;

particularly preferably, an N(R³)₂— group may be selected from

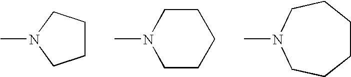

If the radicals R³ are different, one of the radicals R³ may be hydrogen.

X is selected from sulfur, N—R⁴ and in particular oxygen.

R⁴ is selected from straight-chain and branched C₁-C₁₀-alkyl, such as, for example, methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, n-octyl, 2-ethylhexyl, n-nonyl, n-decyl; particularly preferably C₁-C₄-alkyl, such as methyl, ethyl, n-propyl, isopropyl, n-butyl, isobutyl, sec-butyl and tert-butyl, in particular methyl;

A¹ is selected from divalent groups, such as

C₁-C₁₀-alkylene, such as, for example, —CH₂—, —CH(CH₃)—, —(CH₂)₂—, —CH₂-CH(CH₃)—, cis- and trans-CH(CH₃)—CH(CH₃)—, —(CH₂)₃—, —CH₂—CH(C₂H₅)—, —(CH₂)₄—, —(CH₂)₅—, —(CH₂)₆—, —(CH₂)₇—, —(CH₂)₈—, —(CH₂)₉—, —(CH₂)₁₀—; preferably C₂-C₄-alkylene; such as —(CH₂)₂—, —CH₂—CH(CH₃)—, —(CH₂)₃—, —(CH₂)₄— and —CH₂—CH(C₂H₅)—, particularly preferably —(CH₂)₂—, —(CH₂)₃—, —(CH₂)₄— and very particularly preferably —(CH₂)₂—. C₄-C₁₀-cycloalkylene, such as, for example,

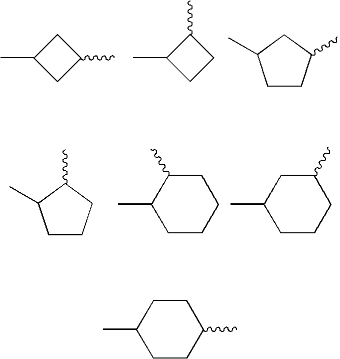

preferably

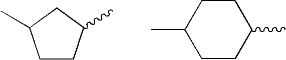

as pure isomers or as an isomer mixture,
and

phenylene, for example ortho-phenylene, meta-phenylene and particularly preferably para-phenylene.

In an embodiment of the present invention, R¹ is hydrogen or methyl. R¹ is very particularly preferably methyl.

In an embodiment of the present invention, R¹ is hydrogen or methyl and R² is hydrogen.

In an embodiment of the present invention, R¹ is hydrogen or methyl and R² is hydrogen and both radicals R³ are identical and are in each case methyl or ethyl.

In an embodiment of the present invention, X—A¹—N(R³)₂ is O—CH₂—CH₂—N(CH₃)₂.

In an embodiment of the present invention, X—A¹—N(R³)₂ is O—CH₂—CH₂—CH₂—N(CH₃)₂.

The amino group in formula I may also be present as a quaternary amino group and, for example, by reaction with an alkylating agent.

In an embodiment of the present invention, ethylene copolymer waxes according to the invention comprise no further comonomers incorporated in the form of polymerized units.

In an embodiment of the present invention, the polymer comprises at least one further comonomer incorporated in the form of polymerized units. Preferred further comonomers incorporated in the form of polymerized units are, for example, isobutene and (meth)acrylates, in particular alkyl (meth)acrylates.

In an embodiment of the present invention, the polymers have a melt flow rate (MFR) in the range of from 1 to 500 g/10 min, preferably from 5 to 200 g/10 min, particularly preferably from 7 to 50 g/10 min, measured at 160° C. and a load of 325 g according to DIN 53735.

In an embodiment of the present invention, the polymers have a kinematic melt viscosity ν in the range of from 500 to 10 000 mm²/s, preferably in the range of from 800 to 4000 mm²/s, measured according to DIN 51562.

In an embodiment of the present invention, the melting ranges of the polymers are in the range of from 60 to 115° C., preferably in the range of from 65 to 110° C., determined by DSC according to DIN 51007.

In an embodiment of the present invention, the melting ranges of the polymers may be broad and may relate to a temperature range of at least 5 to not more than 20° C., preferably at least 7° C. to not more than 15° C.

In an embodiment, the melting points of the polymers are sharp and are in a temperature range of less than 2° C., preferably less than 1° C., determined according to DIN 51007.

In an embodiment of the present invention, the density of the polymers is from 0.89 to 1.10 g/cm³, preferably from 0.92 to 0.94 g/cm³, determined according to DIN 53479.

The polymers may be alternating copolymers, block copolymers or preferably random copolymers.

The preparation of such polymers is known and is also described, for example, in WO 2005/033155.

The polymers can advantageously be prepared by free radical copolymerization of olefins, in particular ethylene, and, if appropriate, the further monomers under high-pressure conditions. The polymerization process is carried out, for example, in stirred high-pressure autoclaves or in high-pressure tubular reactors or in combinations of a high-pressure autoclave and a high-pressure tubular reactor, which are connected in series. The procedure in stirred high-pressure autoclaves is preferred.

Suitable pressure conditions for the polymerization process according to the invention are from 500 to 4000 bar, preferably from 1500 to 2500 bar. Conditions of this type are also referred to below as high pressure. The reaction temperatures are in the range of from 170 to 300° C., preferably in the range of from 195 to 280° C.

The copolymerization can be carried out in the presence of at least one regulator. For example, hydrogen or at least one aliphatic aldehyde or at least one aliphatic ketone of the general formula III

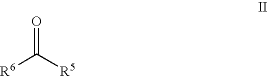

or mixtures thereof are used as regulators.

The radicals R⁵ and R⁶ are identical or different and are selected from
hydrogen;
C₁-C₆-alkyl, such as methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, particularly preferably C₁-C₄-alkyl, such as methyl, ethyl, n-propyl, isopropyl, n-butyl, isobutyl, sec-butyl and tert-butyl;
C₃-C₁₂-cycloalkyl, such as cyclopropyl, cyclobutyl, cyclopentyl, cyclohexyl, cycloheptyl, cyclooctyl, cyclononyl, cyclodecyl, cycloundecyl and cyclododecyl; cyclopentyl, cyclohexyl and cycloheptyl are preferred.

In a particular embodiment, the radicals R⁵ and R⁶ are covalently bonded to one another with formation of a 4- to 13-membered ring. Thus, for example, R⁶ and R⁷ together may be: —(CH₂)₄—, —(CH₂)₅—, —(CH₂)₆, —(CH₂)₇—, —CH(CH₃)—CH₂—CH₂—CH(CH₃)— or —CH(CH₃)—CH₂—CH₂—CH₂—CH(CH₃)—.

Further examples of suitable regulators are alkylaromatic compounds, for example, toluene, ethylbenzene or one or more isomers of xylene. Further examples of very suitable regulators are paraffins, such as, for example, isododecane (2,2,4,6,6-pentamethylheptane) or isooctane.

The conventional free radical initiators, such as, for example, organic peroxides, oxygen or azo compounds, can be used as initiators for the free radical polymerization. Mixtures of a plurality of free radical initiators are also suitable.

Suitable peroxides, selected from commercially available substances, are
didecanoyl peroxide, 2,5-dimethyl-2,5-di(2-ethylhexanoylperoxy)hexane, tert-amyl peroxy-2-ethylhexanoate, dibenzoyl peroxide, tert-butyl peroxy-2-ethylhexanoate, tert-butyl peroxypivalate, tert-amyl peroxypivalate, tert-butyl peroxydiethylacetate, tert-butyl peroxydiethylisobutyrate, 1,4-di(tert-butylperoxycarbonyl)cyclohexane as an isomer mixture, tert-butyl perisononanoate 1,1-di-(tert-butylperoxy)-3,3,5-trimethylcyclohexane, 1,1-di-(tert-butylperoxy)cyclohexane, methyl isobutyl ketone peroxide, tert-butyl peroxyisopropyl carbonate, 2,2-di-tert-butylperoxy) butane or tert-butyl peroxyacetate;
tert-butyl peroxybenzoate, di-tert-amyl peroxide, dicumyl peroxide, the isomeric di-(tert-butylperoxyisopropyl)benzenes, 2,5-dimethyl-2,5-di-tert-butylperoxyhexane, tert-butyl cumyl peroxide, 2,5-dimethyl-2,5-di(tert-butylperoxy)-hex-3-yne, di-tert-butyl peroxide, 1,3-diisopropylbenzene monohydroperoxide, cumyl hydroperoxide or tert-butyl hydroperoxide; or
dimeric or trimeric ketone peroxides or cyclic peroxides of the general formulae IIIa to IIIc.

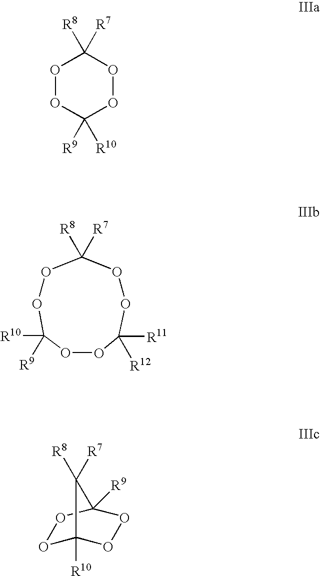

The radicals R⁷ to R¹² are identical or different and are selected from
C₁-C₈-alkyl, such as methyl, ethyl, n-propyl, isopropyl, n-butyl, sec-butyl, isobutyl, tert-butyl, n-pentyl, sec-pentyl, isopentyl, n-hexyl, n-heptyl, n-octyl; preferably linear C₁-C₆-alkyl, such as methyl, ethyl, n-propyl, n-butyl, n-pentyl, n-hexyl, particularly preferably linear C₁-C₄-alkyl, such as methyl, ethyl, n-propyl or n-butyl, very particularly preferably methyl and ethyl;
C₆-C₁₄-aryl, such as phenyl, 1-naphthyl, 2-naphthyl, 1-anthryl, 2-anthryl, 9-anthryl, 1-phenanthryl, 2-phenanthryl, 3-phenanthryl, 4-phenanthryl and 9-phenanthryl, preferably phenyl, 1-naphthyl and 2-naphthyl, particularly preferably phenyl.

Peroxides of the general formulae IIIa to IIIc and processes for their preparation are disclosed in EP-A 0 813 550.

Di-tert-butyl peroxide, tert-butyl peroxypivalate, tert-butyl peroxyisononanoate or dibenzoyl peroxide or mixtures thereof are particularly suitable as peroxides. Azobisisobutyronitrile (“AIBN”) may be mentioned by way of example as an azo compound. Free radical initiators are metered in amounts customary for polymerizations.

So-called desensitizers are added to numerous commercially available organic peroxides before they are sold, in order to give them better handling properties. Suitable desensitizers are, for example, white oil or hydrocarbons, such as, in particular, isododecane. Under the conditions of the high-pressure polymerization, such desensitizers may regulate the molecular weight. In the context of the present invention, the use of molecular weight regulators is to be understood as meaning the additional use of further molecular weight regulators over and above the use of such desensitizers.

The ratio of comonomers during the metering usually does not correspond exactly to the ratio of the units in the polymer.

The comonomer and olefin or comonomers and olefins can be metered together or separately.

The polymerization process can alternatively be carried out in the absence or in the presence of solvents, mineral oils, white oil and other solvents which are added during the polymerization in the reactor and were used for desensitizing the free radical initiator or initiators not being considered as solvents in the context of the present invention. Suitable solvents are, for example, toluene, isododecane and isomers of xylene.

The polymerization process gives the polymers, from which any residual monomer still present can advantageously be removed, for example with the aid of an extruder.

In another embodiment of the present invention, polymers having units which are derived from the monomers (b) are prepared by preparing polymers by copolymerization of ethylene and at least one comonomer having a functional group and then reacting said polymers in a polymer-analogous reaction with at least one substance which has at least one alkylated or cycloalkylated amino group and a spacer to which is attached a reactive group which is capable of reacting with the functional group on at least one comonomer incorporated in the form of polymerized units.

For example, by copolymerization of ethylene with at least one comonomer of the general formula IV,

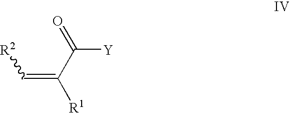

it is possible to prepare a polymer and to react this polymer with at least one compound of the formula V

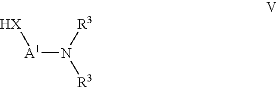

if appropriate in the presence of a catalyst, preferably of an acidic catalyst,
Y being selected from OH and O—R¹³ and
R¹³ C₁-C₄-alkyl, such as methyl, ethyl, n-propyl, isopropyl, n-butyl, isobutyl, sec-butyl and tert-butyl.

The copolymerization of ethylene with at least one comonomer having a functional group can be carried out as above.

The polymer-analogous reaction can be carried out, for example, in a solvent.

Ionic polymers are also suitable. These are obtainable, for example, by reacting polymers with Brøonsted acid.

By reacting polymers with Brønsted acid, the amino groups present in the polymers are partly or completely protonated.

Suitable Brønsted acids are, for example, aqueous mineral acids, such as hydrohalic acids, for example HCl, HBr, HI, HF, H₂SO₄, H₃PO₄, HClO₄, HNO₃; acids of pseudohalogens, such as, for example, HSCN and isocyanic acid, acidic salts, such as alkali metal hydrogen sulfates, for example KHSO₄ and NaHSO₄, alkali metal dihydrogen phosphates, such as, for example, NaH₂PO₄ and KH₂PO4, organic acids, such as, for example, CH₃OSO₃H, formic acid, acetic acid, oxalic acid or citric acid.

In the preparation of ionic polymers, it is possible to start from the above polymers having amino groups. The polymer can, for example, be heated in an autoclave or a kettle and at least one Brønsted acid and, if appropriate, further substances, for example water, are added, the sequence of the addition of Brønsted acid or Brønsted acids and, if appropriate, further substances being arbitrary. The resulting emulsion is homogenized, for example by mechanical or pneumatic stirring or by shaking. Heating to a temperature above the melting point of the polymer or polymers is advantageously effected. Advantageously, heating is effected to a temperature which is at least 10° C., particularly advantageously to a temperature which is at least 30° C., above the melting point of the polymers.

In an embodiment of the present invention, Brønsted acid or Brønsted acids is or are added in an amount such that at least half, preferably at least 60 mol %, of the amino groups of the polymer or polymers is protonated.

In an embodiment of the present invention, Brønsted acid or Brønsted acids is or are added in an amount such that the amino groups of the polymer are quantitatively protonated.

Polymers having quaternary amino groups are obtainable, for example, by reacting polymers with an alkylating agent R¹¹—Z, where R¹¹ is selected, for example, from benzyl and C₁-C₁₀-alkyl and in particular benzyl and methyl, and Z is selected from halogen, preferably chlorine, bromine or iodine, and R¹¹SO₄.

As a result of the reaction, the amino groups present in the polymers are partly or completely alkylated (quaternized).

For the preparation of the polymers having quaternary amino groups, it is possible to proceed as above, and the alkylating agent is accordingly added.

In an embodiment of the present invention, alkylating agent is added in an amount such that at least half, preferably at least 60 mol %, particularly preferably 100% of the amino groups of the polymer are alkylated to quaternary amino groups.

As a result of the above preparation process, solutions or dispersions, preferably aqueous solutions or dispersions of the polymers are obtained.

The solutions or dispersions of the polymers (without quaternary amino groups) preferably have a pH of from 1 to 6.5, particularly preferably from 1.5 to 5.

The solutions or dispersions of the polymers having quaternary amino groups preferably have a pH of from 7 to 10, preferably of from 8 to 9.5.

The solids content of the solutions or dispersions can be chosen within wide ranges. Suitable solids contents are, for example, from 0.1% by weight to 50% by weight.

Regarding Other Constituents

In a further preferred embodiment, the composition also comprises starch in addition to the polymer.

In this context, starch is to be understood as meaning any natural, modified or degraded starch. Natural starches may consist of amylose, amylopectin or mixtures thereof. Modified starch may be oxidized starch, starch ester or starch ether. Anionically, cationically, amphoterically or nonionically modified starch is suitable.

The molecular weight of the starch can be reduced by hydrolysis (degraded starches). Suitable degradation products are oligosaccharides or dextrins. The starch may originate from various sources; it may be, for example, cereal, corn or potato starch, in particular, for example, starch from corn, waxy corn, rice, tapioca, wheat, barley or oats.

Potato starch or modified or degraded potato starch is preferred.

In particular, the composition comprises from 10 to 100 parts by weight, particularly preferably from 50 to 100% by weight, of polymer and from 90 to 0 parts by weight, particularly preferably from 50 to 0% by weight, of starch, based on 100 parts by weight of the sum of polymer and starch.

The composition may comprise further constituents, and suitable additives are described, for example, in WO 2004/092483; polyglyceryl esters may be mentioned by way of example.

The concomitant use of further additives is, however, not absolutely essential in the context of the present invention; in particular, no further additives are required for the improved adhesion of the toner.

It is preferably an aqueous composition, in particular a composition in which the polymer and, if appropriate, the starch are dissolved or dispersed.

The composition can be applied by conventional processes to the substrates to be printed on; processes in which the composition does not diffuse into the substrate or scarcely diffuses into the substrate are preferred, for example application by means of a film press, by spraying or by curtain coating.

The solids content of the aqueous composition may be, for example, from 2 to 70% by weight, preferably from 10 to 60% by weight.

Regarding the process and the substrates to be printed on

The substrates pretreated with the composition are preferably printed on in an electrophotographic printing process.

An essential feature of electrophotographic printing processes is that electrostatically charged dye systems, so-called toners, are used and an electrostatic charge image which can be developed in various ways is produced.

The electrostatic printing process referred to as LEP (liquid electrostatic printing) or indigo printing process is particularly preferred.

An essential feature of this printing process is the use of a liquid toner which is present as a liquid or as a viscous paste at room temperature (20° C.).

The temperature at which the toner is fixed on the substrate is relatively low in comparison with other electrostatic processes and is, for example, from 40 to 100° C.

The substrate to be printed on may be, for example, paper or polymer film.

It is preferably uncoated paper, i.e. base paper, which is not coated with a paper coating slip, but other paper grades may also be treated therewith in order to improve the adhesion of liquid toner.

In particular, the substrate to be printed on may also be wood-free paper.

The substrate to be printed on is pretreated, in particular coated (see above), with the composition. The amount of the composition is preferably from 0.05 g/m² to 15 g/m² (solid), preferably from 0.1 g/m² to 5 g/m² (solid).

By using the pretreated substrates outstanding results are obtained in conventional printing processes, but in particular in electrostatic processes and preferably in the LEP process. The adhesion of the toner on the substrate is very good and the printed image has a high quality.

### EXAMPLES

Preparation of the Polymer

General Method:

In a high-pressure autoclave as described in the literature (M. Buback et al., Chem. Ing. Tech. 1994, 66, 510), ethylene and a comonomer (b) according to table 1 were copolymerized continuously. For this purpose, ethylene (12.0 kg/h) was fed continuously into the high-pressure autoclave under the reaction pressure of 1700 bar. Separately therefrom, the amount of comonomer (b) (=dimethylaminoethyl methacrylate) stated in table 1 was compressed to an intermediate pressure of about 260 bar and then fed continuously into the high-pressure autoclave under the reaction pressure of 1700 bar with the aid of a downstream compressor. Separately therefrom, the amount of initiator solution stated in table 1 and consisting of tert-amyl peroxypivalate, in isododecane (for concentration, cf. table 1), was fed continuously into the high-pressure autoclave under the reaction pressure of 1700 bar. Separately therefrom, the amount of propionaldehyde or isododecane stated in table 1 was compressed to an intermediate pressure of about 260 bar and then fed continuously into the high-pressure autoclave under the reaction pressure of 1700 bar with the aid of a downstream compressor. The reaction temperature was about 220° C. Ethylene copolymer having the analytical data shown in table 2 was obtained.

TABLE 1
Preparation of copolymer

| | T_{Reactor} | Ethylene | DMAEMA | ID | PA | PO in | | | Discharge |
|---|---|---|---|---|---|---|---|---|---|
| No. | [° C.] | [kg/h] | [ml/h] | [ml/h] | [ml/h] | ID [l/h] | c(PO) | C | EC [kg/h] |
| 1 | 220 | 12 | 1000 | 1000 | 0 | 1.74 | 0.025 | 24 | 4.0 |
| 2 | 208 | 12 | 1000 | 0 | 0 | 1.54 | 0.020 | 22 | 3.8 |
| 3 | 220 | 12 | 1000 | 0 | 690 | 1.90 | 0.025 | 17 | 2.7 |

T_{Reactor} is to be understood as meaning the maximum internal temperature of the high-pressure autoclave.
Abbreviations: DMAEMA: dimethylaminoethyl methacrylate, ID: isododecane (2,2,4,6,6-pentamethylheptane), PO: tert-amyl peroxypivalate, EC: ethylene copolymer
PO in ID: Solution of tert-amyl peroxypivalate in isododecane
c(PO): Concentration of PO in ID in mol/l
C: Conversion, based on ethylene and stated in % by weight

TABLE 2
Analytical data of the ethylene/DMAEMA copolymers

| | Ethylene | DMAEMA | Ethylene | DMAEMA | | | |
|---|---|---|---|---|---|---|---|
| | content | content | content | content | ν | Tₘₑₗₜ | ρ |
| No. | [% by wt.] | [% by wt.] | [mol %] | [mol %] | [mm²/s] | [° C.] | [g/cm³] |
| 1 | 72.9 | 26.9 | 93.8 | 6.2 | 10000 | 85.1 | 0.9263 |
| 2 | 70.3 | 29.4 | 93.0 | 6.9 | 19800 | 83.7 | 0.9301 |
| 3 | 73.3 | 26.7 | 93.9 | 6.1 | 160 | 74.2 | 0.9252 |

“Content” is to be understood as meaning the proportion of ethylene or DMAEMA incorporated in the form of polymerized units in the respective copolymer.
ν: kinetic melt viscosity, measured at 120° C. according to DIN 51562.

The content of ethylene and DMAEMA in the copolymers 1.1, 1.2 and 1.3 was determined by ¹H-NMR spectroscopy. The density was determined according to DIN 53479. The melting point Tₘₑₗₜ or melting range was determined by DSC (differential scanning calorimetry, differential thermal analysis) according to DIN 51007.

Application of the Starch/Polymer Mixtures:

An oxidatively degraded potato starch was heated according to the manufacturer's instructions at a concentration of 20% in water for 30 minutes to 95° C. Thereafter, the starch solution was diluted to 10% solids content and cooled to about 60° C. Formulations were prepared from this starch solution and the polymers described in the examples, the solids content of the prepared formulation being adjusted to 10%. These mixtures were applied to a wood-free paper (basis weight 90 g/m²) by means of a size press. Thereafter, the papers were dried by contact drying at 90° C. and then conditioned for 24 h at a relative humidity of 50% and a temperature of 24° C. The papers were then calendered (1 nip, 100 daN/cm).

The printing experiments were carried out on a Hewlett-Packard Indigo Digital printing press 3000. The toner adhesion was determined according to the tape pull method (DIN V EN V 12283) using a 3M #230 adhesive tape. For this purpose, the adhesive tape was stuck onto the printed surface without bubbles and then peeled off at constant speed at an angle of almost 180°. After the pick test, the ink density of the print was determined by means of a densitometer and stated as a value in the table of results. The determination of the toner adhesion or of the ink density after the pick test was effected after certain time intervals (immediately/1 min/10 min/1 h/24 h).

| | Polymer | Polymer | Starch | | | | | |
|---|---|---|---|---|---|---|---|---|
| Use | from | weight | weight | Ink density | | | | |
| example | example | fraction | fraction | immediately | 1 min | 10 min | 1 h | 24 h |
| a | | 0 | 100 | 25 | 32 | 46 | 82 | 91 |
| b | 1 | 55 | 45 | 56 | 74 | 90 | 98 | 100 |
| c | 2 | 55 | 45 | 66 | 86 | 98 | 100 | 100 |
| d | 1 | 100 | 0 | 54 | 83 | 96 | 99 | 100 |
| e | 2 | 100 | 0 | 78 | 97 | 99 | 100 | 100 |

1. A process for printing substrates, wherein the substrates are pretreated with a composition which comprises a polymer produced by the free radical polymerization of ethylenically unsaturated monomers, referred to below as polymer for short, wherein at least 40% by weight of the monomers are olefins.

2. The process according to claim 1, wherein the olefins are ethylene, propylene or isobutylene or mixtures thereof.

3. The process according to claim 1, wherein ethylene is present.

4. The process according to claim 1, wherein the polymer comprises unsaturated monomers having primary, secondary, tertiary or quaternary amino groups.

5. The process according to claim 1, wherein the polymer is composed of
(a) from 50 to 99% by weight of olefins,
(b) from 1 to 50% by weight of at least one monomer having a primary, secondary, tertiary or quaternary amino group and
(c) from 0 to 30% by weight of a further monomer.

6. The process according to claim 1, wherein the polymer is present in the form of an aqueous dispersion, emulsion or solution.

7. The process according to claim 1, wherein the polymer has a weight average molecular weight of from 1000 to 500 000 g/mol.

8. The process according to claim 1, wherein the composition also comprises starch in addition to the polymer.

9. The process according to claim 1, wherein the composition comprises from 10 to 100 parts by weight of polymer and from 0 to 90 parts by weight of starch, based on 100 parts by weight of the sum of polymer and starch.

10. The process according to claim 1, wherein the composition is an aqueous solution, emulsion or dispersion.

11. The process according to claim 1, wherein the printing process is an electrophotographic process.

12. The process according to claim 1, wherein the printing process is the LEP process (liquid electrophotographic printing).

13. The process according to claim 1, wherein the substrate to be printed is paper or polymer film.

14. The process according to claim 1 wherein the substrate to be printed is uncoated paper.

15. The process according to claim 1, wherein the substrate to be printed is wood-free paper.

16. The process according to claim 1, wherein the substrate is coated or impregnated with the composition.

17. The process according to claim 1, wherein the substrate is coated or impregnated with from 0.05 g/m² to 15 g/m², of the composition (solid).

18. A printed substrate obtainable by the process according to claim 1.

19. A paper which is coated or impregnated with a composition according to claim 1.
